(19) United States
(12) Patent Application Publication
(10) Pub. No.: US 2011/0163248 A1
(43) Pub. Date: Jul. 7, 2011

(54) MULTI-LAYER LIGHT-WEIGHT GARMENT MATERIAL WITH LOW RADIATION BUILDUP PROVIDING SCATTERED-RADIATION SHIELDING

(76) Inventor: Thomas J. Beck, Baltimore, MD (US)

(21) Appl. No.: 12/982,447

(22) Filed: Dec. 30, 2010

Related U.S. Application Data
(60) Provisional application No. 61/291,310, filed on Dec. 30, 2009.

(51) Int. Cl. G21F 3/02

(52) U.S. Cl. 250/516.1; 250/519.1

(57) ABSTRACT

A multi-ply, preferably flexible, x-ray shielding material which can be formed into a garment is provided. Such material is lighter in weight but that provides a specific degree of protection under the standard conditions met in fluoroscopy by workers in the field subjected to reflected, or scattered, radiation emanating from the patient's body. The multi-layered fabric is so constructed that the amount of re-radiated energy, or fluorescence produced by each layer, is greatly attenuated. Generally, this invention is directed to a material formed of two or more layers of a polymeric or elastomeric film or sheet loaded with different radiation-attenuating metal material.

The priority of copending provisional application No. 61/291,310, filed on Dec. 30, 2009, is hereby claimed and the specification and description is hereby incorporated by reference as if fully repeated herein.

### BACKGROUND OF THE INVENTION

The present invention relates to a flexible radiation protective garment material that is light in weight and designed to reduce, by a specific percentage, exposure of the wearer to x-ray radiation scattered by human or animal tissues that are being imaged by a fluoroscope operating at 110 keV or less. The material is designed so that it is substantially lighter than the amount of lead required to provide the same degree of protection, due to its low net radiation buildup and higher attenuation coefficient at certain x-ray energies.

### BRIEF SUMMARY OF THE INVENTION

In the medical field, personnel are often required to work in close proximity to patients undergoing imaging procedures involving x-rays, commonly referred to as fluoroscopy. The hazard to the worker arises from x-rays scattered by the patient's body toward the worker. Although such scattered radiation has a lower energy level than the direct x-ray beam, it does maintain its ionizing potential. Exposure to this scattered radiation has the potential to produce a significant radiation hazard over the working lifetime of the worker. For this reason, workers traditionally wear a radiation shielding garment that places a protective barrier between the scattering tissues of the patient and the body of the worker. Traditionally such garments are made from a flexible rubber or polymer material within which is embedded powdered lead, a good absorber of x-rays. Unfortunately lead garments are heavy, and can cause significant injury to the wearer with daily use over a working lifetime. There has thus begun a search for lighter weight materials which can provide equivalent protection under the conditions of this job.

An underlying principle of such reduced weight garments is that for a large portion of the x-ray energy levels commonly used in medical procedures, certain elements, typically with atomic numbers between 50 and 70, provide greater attenuation per unit weight than lead. Until now, most workers have assumed that the testing of the effectiveness of such elements other than lead requires meeting the requirements of shielding from the effects of the direct x-ray beam from the x-ray source. It is now realized, however, that the danger to the worker is primarily caused by radiation reflected from the patient's body, so-called “scattered radiation”. This is shown in the illustration of FIG. 1. An additional problem, however, arises from the fact that many of these lower atomic number heavy metals reradiate the x-rays they absorb, albeit at lower energy levels. This can lead to a problem where the exposure to the wearer is greater than that evident from the attenuation tests. The problem has potentially increased because the industry has gone to light weight aprons which employ tin or antimony, and other low atomic number elements, which are much more likely to emit higher levels of radiation.

### OBJECTS OF THIS INVENTION

It is therefore an object of this invention to provide protection for workers continually exposed to such scattered radiation as part of their work, for example as clinical technicians operating patient fluoroscopes in medical offices and laboratories. It is a further object of this invention to provide lighter weight, but effectively shielding, garments formed of flexible material loaded with metal material that provides the desired effective shielding, or attenuation, of the scattered radiation, at a lower total weight. It is a further object of this invention to combine two or more layers of shielding material so as to also reduce the exposure of the worker to secondary radiation produced in each layer of the garment as it absorbs the scattered radiation, The addition of secondary radiation to the transmitted radiation is termed build-up. This invention takes into account both of these effects, and it has been found can provide greater effective protection to the worker, who is continually exposed to such buildup radiation, as well as to scattered radiation.

### GENERAL DESCRIPTION OF THE INVENTION

These and other advantages are achieved in accordance with this invention, by which there is provided a multi-ply, preferably flexible, shielding material which can be formed into a garment. There is also provided a method for producing such material, that is lighter in weight but that provides a specific degree of protection under the standard conditions met in fluoroscopy. The advantages of this invention is that it protects the worker from both the small amount of transmitted direct radiation to which a worker would otherwise be exposed, and the reflected radiation emanating from the patient's body, which is more usually actually encountered, while also compensating for the greater degree of build-up from the re-radiated scattered radiation generally found with the elements used in so called light-weight protective garments. At least at the x-ray energies used in medical imaging, or fluoroscopy, this invention avoids negating the protective advantage apparent in the attenuation test, which would otherwise result from the re-radiation from the lower atomic number elements.

Generally, this invention is directed to a material formed of two or more layers of a polymeric or elastomeric film or sheet loaded with radiation-attenuating metal material. The invention is intended for protection when using the conventional fluoroscopic energies of about 110 keV or less. A preferred first layer would be filled with a metallic element having an atomic number in the range of from 56 to 65. The theoretically preferred material is Gadolinium, because of its k-edge level of 50.2 keV, just below the energies of the scattered x-rays, effective to attenuate the scattered radiation from the fluoroscopic beam. As these elements have a relatively high re-radiation effect, however, the second barrier layer, in a two-layer product, intended to be closest to the skin, should absorb any re-radiation build-up, as well as any lower energy radiation that may have passed through the first layer. A relatively low weight barrier layer of lead is preferred for this simple two-ply material. However, in the preferred three-layer system, it has been found that compounds in the range of atomic number of 55 to 59 are effective for the innermost layer, with praseodymium being theoretically most preferred. However, because of its rarity, and resulting high cost, in the preferred atomic number range, barium and cesium are relatively common, and useful for this purpose. However, because of its chemical activity, cesium should be used in the form of a compound, such as cesium iodide or cesium chloride, for example. If desired any of the attenuating metal elements can be present in the form of a compound relatively inert in the environment of the polymeric matrix, instead of its elemental metal form.

### DESCRIPTION OF THE DRAWINGS

FIG. 1 is a diagrammatic sketch exemplifying the exposure conditions met by operators of medical x-ray systems from scattered radiation;

FIG. 2 is a diagrammatic sketch exemplifying the setup used for determining lead equivalence by comparing radiation attenuation of a test material to that obtained from, lead foil standards with known thickness and purity when exposed to the direct x-ray beam, as shown in FIG. 2;

FIG. 3 is a diagrammatic sketch exemplifying a system for determining extent of protection afforded by a particular material with respect to scatter radiation;

FIG. 4 is a graph showing a scatter radiation spectrum from a 110 keV beam from a water medium;

FIG. 5 are graphs showing the effect on the transmitted scatter spectrum with and without a second layer attenuating fluorescent emissions from a Gadolinium first layer; and

FIG. 6 are graphs showing the effect on the transmitted scatter spectrum with and without a final layer of antimony attenuating fluorescent emissions from layers of Gadolinium and Barium.

### DETAILED DESCRIPTION OF THE INVENTION

### Standard Test Conditions

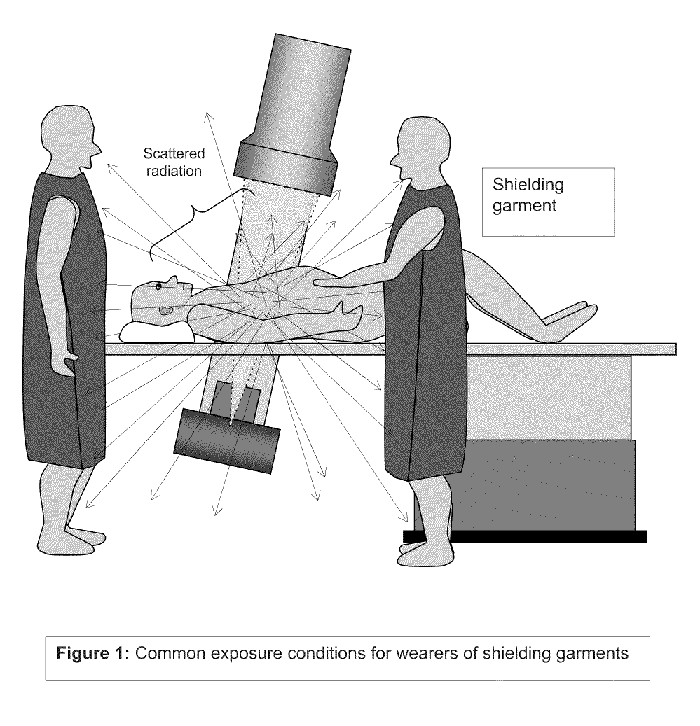

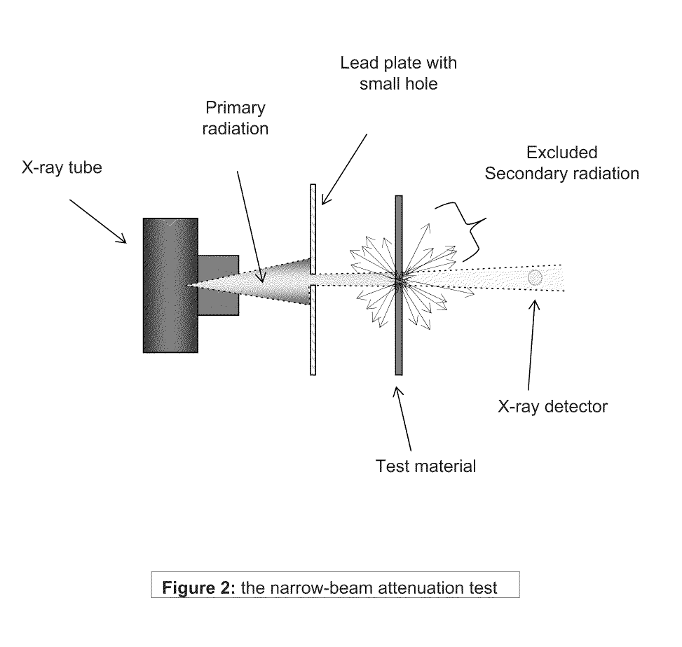

In determining the effectiveness of the combinations of the present invention, the usual basis for specifying the effectiveness, i.e., based upon its lead equivalence when exposed to the direct x-ray beam, is not relevant. Lead equivalence normally is determined by comparing radiation attenuation of a test material to that obtained from lead foil standards with known thickness and purity when exposed to the direct x-ray beam, as shown in FIG. 2. However, such a standard could be also used when using testing the shielding under real conditions, i.e., where the reradiated and scattered radiation is paramount, rather than the radiation from the primary x-ray beam, as is shown in FIG. 1. For the purposes of this invention, to show the effectiveness of these combinations, the protection will be specified in terms of percent reduction in exposure, e.g., 90%, not in terms of lead equivalence. However to compare with the effects previously obtained, the lead equivalence can also be shown.

For the purpose of simulation, the scatter will be computed using x-ray spectra produced by the SpekCalc program at 110 keV with a 15° tungsten target filtered by 1 mm Al. Mass Compton attenuation coefficients for water were obtained from NIST XCOMP. It has been found that this scattered radiation from a patient's body can be generally approximated for test purposes, by utilizing a volume of water, 30 cm on a side, i.e., 30 cm³, from a tungsten target x-ray tube operated at between 70 and 130 keV. Scattered radiation is assumed to be emitted from a point source in the center of the beam entrance surface, i.e., attenuated by 15 cm of water.

The invention is directed to various multi-layer materials, having two or more layers, comprising a number of different combinations of different materials in different layers arrayed in specific order, that result in a desired protection level under standard exposure conditions, but with a lower weight than that required for a pure lead garment.

The invention is based upon the recognition that the best results can be obtained by matching the k-edge values, in electron volts, to the particular strength of the direct x-radiation and the system into which the direct radiation is focused. This helps to determine the best combination of the attenuation value of various metal elements as well as the fluorescent secondary re-radiation produced by those elements. Mass photoelectric absorption coefficients for shielding elements were obtained from NIST XCOMP. Emission of k-shell characteristic radiation assumed the absorbed fluence of scattered radiation in a given shielding material using ωₖ, values from Byrne and Horvath J Physics B: Atom Molec Phys. 1970 3:280-292, with relative k-shell characteristic intensities from McCrary et al, Physical Review A, 1971:4:1745-1749.

The present invention provides designs to produce the lightest combination of layered materials that provide a specified level of protection under the specific standard exposure conditions. To accommodate different levels of exposure conditions, three levels of protection are defined. While a lead standard is not proposed, the levels of protection correspond to the typical attenuation produced by 0.25, 0.35 and 0.5 mm of lead in a 100 keV direct beam. These roughly correspond to percent protection, or attenuation, values of 89%, 93% and 97%. The goal is thus to provide the lightest weight formulation that provides these protection values.

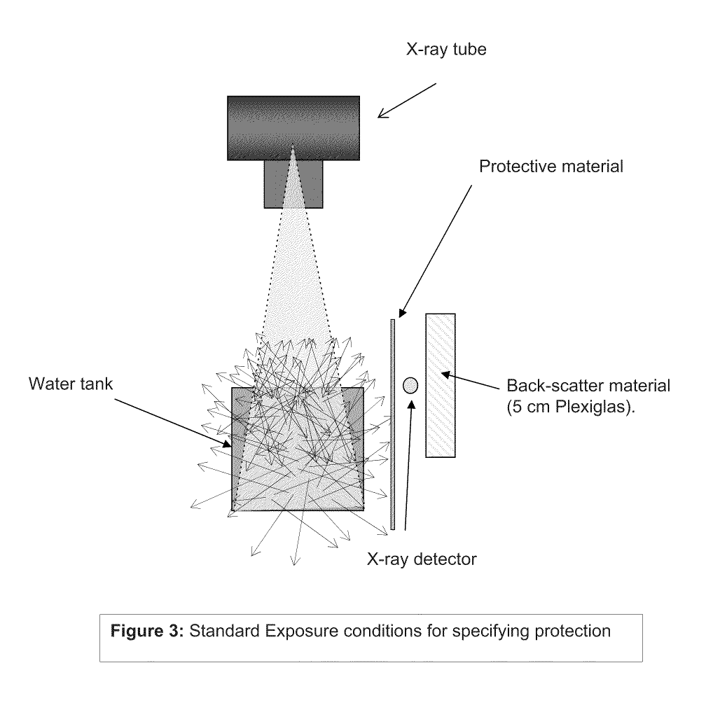

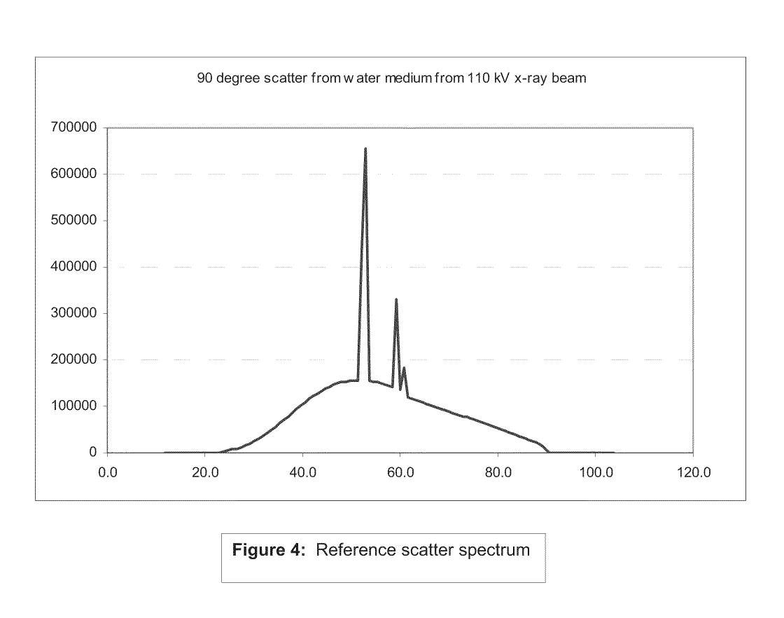

The procedure is to use simulations to produce a series of combinations of materials that appear to provide the desired protection level and that are lower in weight. Combinations that appear to be favorable will be tested using the setup in FIG. 3. In all cases the simulations begin with the scatter spectrum from the 110 keV beam in the water medium as shown in FIG. 4. The simulations compute the radiation transmitted through the test material as well as the k-shell florescence produced by radiation exceeding the k-shell binding energy of the element in question. Only k-shell fluorescence is computed. Simulations are cascaded by using the spectrum emitted/transmitted by one material as incident on the next layer.

The design will employ multiple sequential layers to optimize attenuation while simultaneously minimizing build-up due to fluorescent re-radiation from the attenuating metals.

In terms of attenuation, the order of layers does not matter, but the amount of fluorescent radiation emerging from the last layer will be strongly dependent on the order. Intensity of fluorescence can be minimized by reducing the fraction of the spectrum reaching the layer that stimulates emission, or by interposing a layer that absorbs fluorescence from the previous layer while generating little additional fluorescence of its own. For the purposes of these simulations we have concentrated on the 90° scatter spectrum produced at 100 keV, a reasonable upper end of fluoroscope operational power levels. L-shell fluorescence was ignored and layers were assumed to be thin enough so that emitted fluorescence was not attenuated within the emitting layer. 2π geometry was assumed for emission from a layer, i.e., conservatively 50% of emission would be in the direction of observation.

It has been found that the effectiveness of a particular combination of materials, in reducing exposure of a shielded worker to the radiation, will depend on the x-ray energies present in the x-ray field to which the wearer is exposed. For this purpose a specific exposure condition must be defined that conservatively simulates medical fluoroscopy, the most common condition under which shielding garments are worn.

Modern fluoroscopes employ a tungsten target x-ray tube and are typically operated at kilovoltages between 60 and 110 keV. The fluoroscope positions the x-ray tube and image receptor on opposite sides of the patient. Modern c-arm fluoroscopes can orient the beam in almost any direction but most commonly the patient is recumbent with the x-ray source below and with the beam directed upward, as shown in FIG. 1. Essentially all of the radiation reaching the workers is scattered from the portion of the patient's body within the direct x-ray beam, rather than directly from the x-ray beam. Except for a few percent, the x-rays reaching the worker are produced in the patient's body by the well-known, but previously little appreciated, Compton Effect. Since the human body is largely water, a water volume placed in an x-ray beam provides a good simulator of actual exposure conditions. Since nearly all fluoroscopes are limited to operation below 110 keV, the test conditions will be defined in terms of scatter produced in a water volume by a tungsten target x-ray tube operated at 110 kVp. It has been found to be generally true that the degree of protection defined under these conditions should underestimate the effectiveness of the protection provided at lower kilovoltages. For the purposes of standardization the following conditions are assumed:
The scatter is assumed to be produced within a 30 cm×30 cm×30 cm water volume located with the distal surface at 1 m from the x-ray tube focal spot. The x-ray field size is adjusted to cover the exit surface of the water volume, i.e., 30 cm×30 cm at 1 m from the focus.
The x-ray tube with a tungsten target is operated at 110 keV and at least 2 mm Al filtration.
The scatter is measured at 90 degrees to the axis of the direct beam at a distance of 85 cm from the focus aligned with the midpoint of the entrance surface of the water volume (FIG. 3).
The test material is cut to a size to completely cover the side of the water volume, i.e., 30×30 cm and is placed at a distance of 10 cm from the outer margin of the water volume. Care must be taken to ensure that the test material is not exposed to the direct x-ray beam.
The scatter intensity is detected by a diode type detector calibrated in air kerma or in Roentgens, for example the Radcal DDX6W detector.
The detector is to be placed at a distance of 15 cm from the water volume, i.e., 5 cm from the surface of the test material.
Protection is measured as follows:

$$\% P = ( 1 - \frac{{M}_{1}}{{M}_{2}} ) \times 100$$

Where M₁ is the number of Roentgens measured with the test material, and M2 is the number of Roentgens measured without the test material in place between the water and the detector. Percent protection is expressed as the average of 5 repetitions of the measurement.

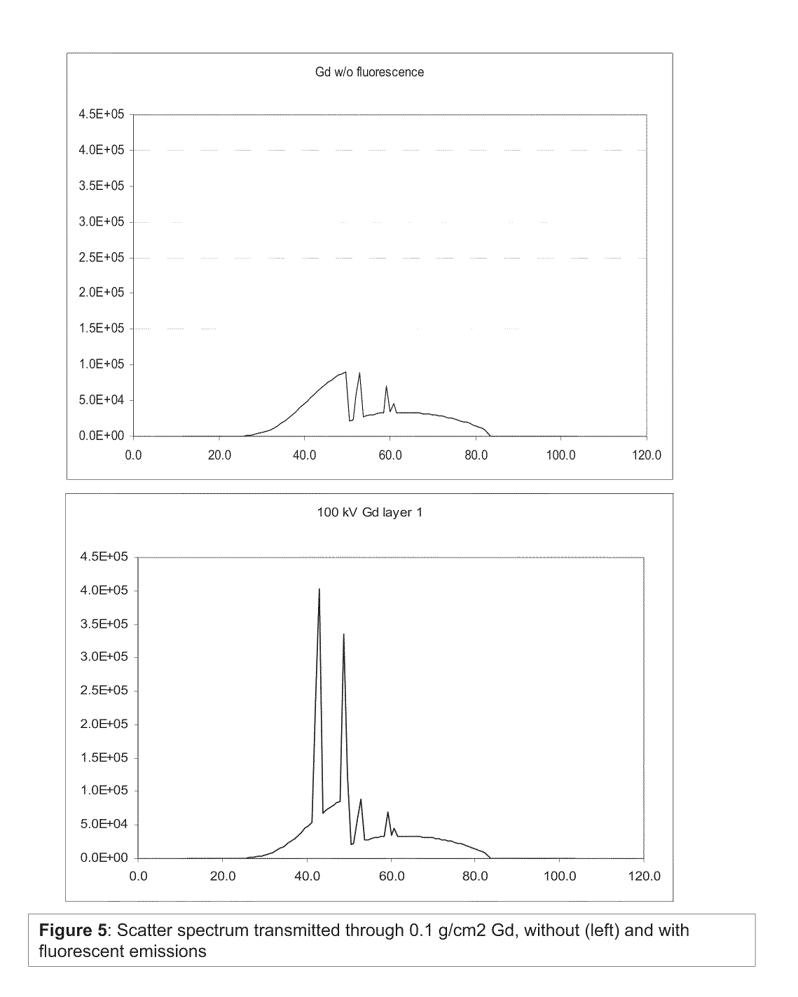

The function of the secondary layer is to attenuate the fluorescent emissions from the Gadolinium layer as well as any radiation transmitted below the k-edge of that element, or that of any other element used in the first layer, as shown in FIG. 5. The next layer should have a k-edge just below the k-alpha-1 line of Gd at 43 keV. The rare element praseodymium would be ideal for that purpose, but again, more readily available, and economically more satisfactory, elements with atomic numbers between 55 and 58 are also favorable. Barium and cesium are relatively available elements that are suitable for the secondary layer. Cesium iodide or cesium chloride, for example would also useful in this secondary layer. A third layer, if desired, should have a k-edge just below the k-alpha-1 line of the element(s) in the second layer. If the second layer comprises barium, a third layer comprising antimony would be ideal; antimony has a k-edge below the 32 keV k-alpha-1 line of barium. Tin and indium would also suffice in layer 3. If a fourth layer is desired, based upon its k-edge value, the unsuitable (radioactive) element technetium would be ideal, but molybdenum or niobium, or their inert compounds, would be more useful.

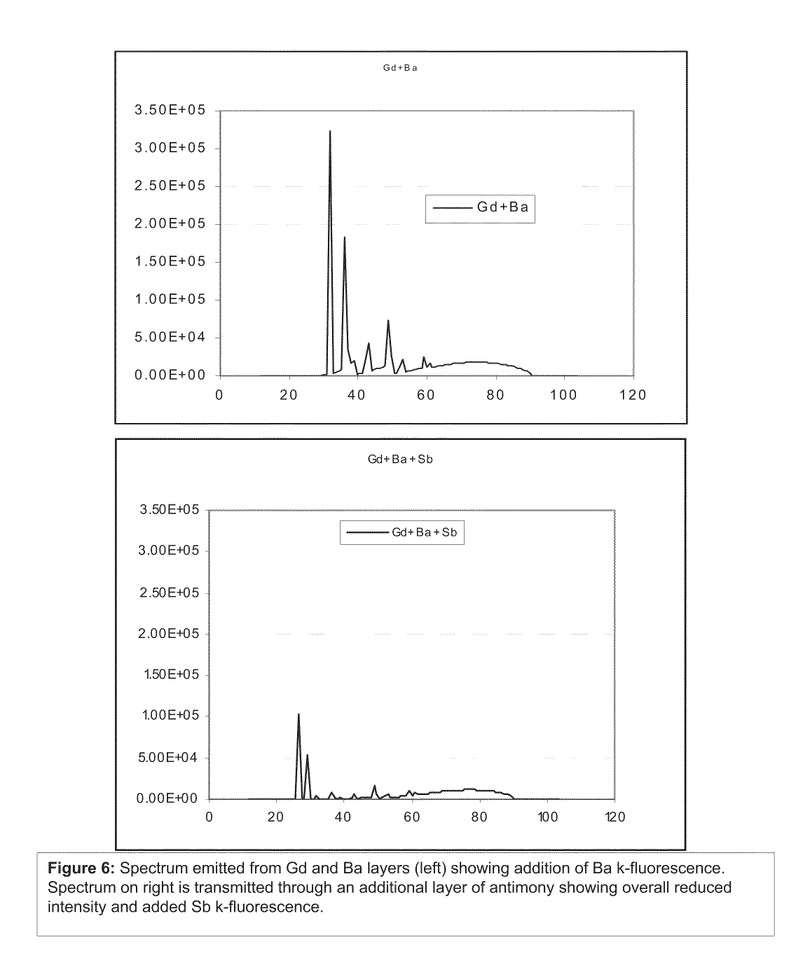

FIG. 6 shows the spectrum emitted from the Gd layer (from FIG. 5) after transmission through a layer of 0.1 g/cm² of Barium. Note the reduction in the Gd fluorescence and the radiation transmitted below the Gd k-edge, as well as the addition of the k-fluorescence from Ba.

The purpose of the layer sequence is to produce the greatest amount of net radiation attenuation for the least weight. The sequence will not totally eliminate any radiation from reaching the wearer but it is designed to reduce exposure by a specified amount e.g., 90% or more. This may be achieved most optimally with three or four layers, but a relatively inexpensive two layer combination of layers of barium and antimony, cesium and tin or barium and tin, will provide a significant (25-30%) weight reduction for a high degree of protection, as compared to lead.

### EXAMPLES

### X-Ray Protective Shielding Garments

In the following examples the outer layer faces the radiation source and the innermost layer is facing the skin of the wearer.

### Example 1

### Two Layers with Gadolinium and Antimony

This example is made of two separate layers. The outer layer would contain gadolinium, in powder form, as either metal or as gadolinium oxide or a salt of gadolinium. The gadolinium weight percentage would be in the range of 60% to 90% dispersed in a flexible vinyl matrix or other flexible matrix, such as an elastomer or polyolefin. The inner layer would consist of antimony in the weight percentage range of 90% to 60% in a flexible polymer matrix.

The cumulative effect of the two layers would reduce the net exposure of the wearer of the apron to the reference scatter beam resulting from the broad beam x-ray conditions by 90% or more (FIG. 4) but with reduced weight compared to equivalent protection provided by a shielding garment apron containing only lead.

### Example 2

### Two Layer with Barium and Antimony

This example is made of two separate layers. The outer layer would contain barium in powder form as either metal or as barium oxide or barium sulfate. The barium weight percentage would be in the range of 60% to 90% dispersed in a flexible vinyl matrix or other flexible matrices such as an elastomer or polyolefin. The inner layer would consist of antimony in the weight percentage range of 90% to 60% in a similar flexible polymer matrix.

The cumulative effect of the two layers would reduce the net exposure of the wearer of the apron to the reference scatter beam resulting from the broad beam x-ray conditions by 90% or more (FIG. 4) but with reduced weight compared to equivalent protection provided by a shielding garment apron containing only lead.

### Example 2A

### Two Layer with a Thallium and Antimony Barrier Layer

A two layer X-Ray Protective apron where:

The “secondary layer” would consist of antimony in the weight percentage range of 60% to 90% in a flexible polymer matrix and barium weight range of 5% to 35% dispersed in a flexible vinyl matrix, or other flexible matrices such as an elastomer.

The “barrier layer” would contain antimony in the weight percentage range of 30% to 60% and thallium in the weight range of 70% to 40% dispersed in a flexible vinyl matrix or other flexible matrices such as elastomers.

For clothing made from these two-layer examples, the barrier layer is closest to the wearer's body.

### Example 3

### Three Layer with Gadolinium, Barium and Antimony

The outermost layer would contain gadolinium in powder form as either metal or as gadolinium oxide or a salt of gadolinium. The gadolinium weight percentage would be in the range of 60% to 90% dispersed in a flexible vinyl matrix or other flexible matrices, such as an elastomer or polyolefin. The middle layer would contain barium in powder form as either metal or as barium oxide or barium salt, such as the sulfate or iodide. The barium weight percentage would be in the range of 60% to 90% dispersed in a flexible polymer matrix. The innermost layer would consist of antimony, as the metal or as an oxide or salt, such as the sulfate, chloride, or iodide, in the weight range of 50% to 90% in a flexible polymer matrix. The cumulative effect of the three layers would reduce the net exposure of the wearer of the apron to the reference scatter beam resulting from the broad beam x-ray conditions by 90% or more (FIG. 4) but with reduced weight compared to equivalent protection provided by a shielding garment apron containing only lead.

### Example 4

### Two Layer with a Multi-Metal Layer

A two layer apron where:

The “secondary layer” would consist of antimony in the weight percentage range of 60% to 90% in a flexible polymer matrix.

The “barrier layer” would contain antimony in the weight percentage range of 60% to 90% and an equal mixture of tungsten and bismuth in the weight range of 35% to 5% dispersed in a flexible vinyl matrix or other flexible matrices such as elastomers. Substantially the same net attenuation is obtained.

This invention further comprises the preparation of X-Ray protective garments, such as Aprons, from multi-layer material where one of the layers contains Lead.

### Example 5

This example is for an apron formed of a material comprising two layers. The “barrier layer” would contain lead in the weight percentage range of 60% to 90%, dispersed in a flexible vinyl matrix or other flexible matrices such as elastomers or polyolefins. The “secondary layer” would consist of antimony, metal or compound, in the weight percentage range of 90% to 60% of the metal, dispersed in a flexible polymer matrix.

Each layer would have an x-ray absorption equivalent to 0.25 mm of lead over the range of 60 keV to 120 keV.

### Example 6

An apron formed from a three-layer material would have the following compositions:

A secondary layer would consist of antimony in the weight range of 50% to 90% and tungsten in the 35% to 5% range in a flexible polymer matrix. A second secondary layer would comprise a composition by weight of 50% to 90% of tungsten in a polymer matrix.

A “barrier layer” would contain lead in the weight percentage range of 90% to 60% dispersed in a flexible vinyl matrix or other flexible matrices such as an elastomer.

Each layer would have the x-ray absorption equivalence of 0.167 mm of lead.

### Example 7

This example is of an apron forming material which has two layers. The “barrier layer” would contain lead in the weight percentage range of 60% to 90% dispersed in a flexible vinyl matrix or other flexible matrices such as elastomers or polyolefins.

The “secondary layer” would consist of barium sulfate or antimony metal in the weight percentage range of 60% to 90% in a flexible vinyl polymer matrix.

The cumulative effect of the two layers would be to produce a broad beam x-ray attenuation that is approximately (within 10%) equivalent to 0.5 mm of pure lead measured at 100 keV. For this two-layer fabric, it is intended that any clothing be formed so that the lead barrier layer is closest to the body of the wearer. The same results would be achieved using other flexible matrices, such as made from elastomers or polyolefins.

### Example 8

A three layer apron can be constructed of two secondary layers and a barrier layer.

The innermost secondary layer would consist of a flexible ethylene polymer matrix loaded with antimony metal, in the weight range of 50% to 90% range. The middle secondary layer would contain Barium sulfate, weight range of 50% to 90% in a flexible ethylene polymer matrix.

The “barrier layer” would contain lead in the weight percentage range of 60% to 90% dispersed in a flexible vinyl matrix or other flexible matrices, such as elastomers or an olefin polymer.

The cumulative effect of the three layers would be to produce a broad beam x-ray attenuation that is approximately (within 10%) equivalent to 0.5 mm of pure lead measured at 100 keV. For this three-layer fabric, it is intended that any clothing be formed so that the lead barrier layer is furthest from the body of the wearer.

The apron of this invention will consist, preferably, of either a two-layer or a three-layer construction. Although a greater the number of layers would allow for lighter weight with equal attenuation, or equal weight with greater attenuation, it becomes economically less feasible as the layers increase in number.

Generally, each layer comprises one high atomic number element with the highest numbered element being used for the so-called ‘barrier’ layer, which limits any direct x-ray radiation that may reach the worker. On a two-layer system, the barrier layer is usually placed on the inside or nearest to the body, while as the number of layers increase, it is usually placed as one of the intermediate layers, or as the outside layer, farthest from the wearer.

Preferred elements are antimony, bismuth, tin, lead and gadolinium, or their compounds, such as bismuth oxide, barium sulfate. Compounds of highly reactive metals, such as cesium halides, such as the chloride or iodide, cesium oxide or carbonate; and the rare earth metal, cerium, and its compounds are possible commercial candidates for consideration.

The polymer matrices found to be useful were formed of polyvinyl chloride, prepared using a plastisol mixing and casting manufacturing route. But any of the thermoplastics, such as polyethylene, can be used with the high atomic number element dispersed within the mixture, and extruded using standard processing techniques. Also of interest might be the use of a low melting point, low viscosity polymer, such as ethylene vinyl acetate copolymer. In addition, elastomers and high solids latex compounds can be usefully the basis for the polymer matrix, the latex being limited only as to certain of the metals or their compounds that are reactive with water are preferably not used.

Although examples of this invention may contain only a single metal in each formulation, mixtures of metals can also be used, such as lead/antimony or tin, used in ratios such as 67% lead/33% antimony or tin or 67% antimony/33% lead. Often the addition of 5% to 20% tungsten to the barrier layer, results in an improved primary x-ray attenuation, with a corresponding weight reduction.

The following examples of Layer Formulations are considered useful:

| | |
|---|---|
| PVC-based matrix: | |
| Gadolinium oxide | 60 pounds |
| PVC plastisol | 40 pounds |
| Powdered lead | 87 pounds |
| PVC plastisol | 13 pounds |
| Antimony (or Tin) | 80 pounds |
| PVC plastisol | 20 pounds |
| Barium Sulfate | 70 pounds |
| PVC plastisol | 30 pounds |
| Latex-Based Matrix: | |
| Gadolinium(Gd) | 60 pounds |
| Latex | 40 pounds (20 pounds dried matrix) |
| Antimony (or Tin) | 90 pounds |
| Latex | 20 pounds (10 pounds dried matrix) |
| Thermoplastic-Based Matrix: | |
| Lead | 85 pounds |
| Polyethylene | 15 pounds |
| Antimony | 80 pounds |
| Ethylene/vinyl acetate copolymer | 20 pounds |

### Further Examples of a Multi-Layer Protective Apron Patent

### Example 9

Useful Two-layer materials having a secondary radiation layer placed on the outer surface and an inner barrier layer made of lead impregnated elastomer, are described in these examples: In these examples, the outer, secondary radiation layer is also constructed of an elastomer having dispersed therein, i.e., “filled”, with one or more of the following metals, in elemental form or as an inert compound: indium, antimony, tin, cesium iodide, cesium chloride, barium sulfate and gadolinium oxide. The concentrations of the elemental metal in the two layers will range from 30% to 70% lead in the barrier layer, and up to 70% by weight of the other high atomic number metal in the secondary radiation layer. It should be noted that the iodide in the cesium iodide compound, contributes to the radiation attenuating effect, due to its high atomic number. The total mass of metal in the two layers can be adjusted to reduce the net radiation exposure of a wearer of an apron made from the two-layer material, under the radiation scatter conditions, by between 90 and 95%.

### Example 10

Useful three-layer materials having a secondary radiation layer placed on the inner surface and an outer or intermediate barrier layer filled with lead are described in the following examples: Unlike the two-layer design, the three or more layers of material can be ordered in ascending atomic number from the inner (adjacent the wearer) outward, or the heaviest metal can be an intermediate layer. The inner layer can again be formed of an elastomer filled with a relatively lighter element (atomic number of not greater than 56, selected from one or more of antimony, tin, and indium metal, and compounds of these elements, and compounds of more reactive elements, such as cesium compounds, such as the chloride or the iodide, and barium sulfate. The middle layer is constructed of an elastomer layer impregnated with a medium atomic number element (not greater than 72), such as cerium or samarium as metal or gadolinium as oxide. The outermost layer is an elastomer impregnated with bismuth, lead, tungsten or tantalum. The proportions of total metal in the three layers will range from equal proportions in all three layers to 10% in the middle and outermost layers with the remainder in the inner layer. The total metal mass in the three layers is adjusted, to reduce the net exposure to radiation by between 90 and 95%, by a wearer of an apron made from the material, under the reference scatter radiation conditions.

The industry had recognized the problem of secondary radiation, or re-radiation from the higher atomic number metals other than lead. An X-ray protective apron uses such metals to absorb radiation to which a technician, surgeon or vet may be exposed, in the course of x-raying a patient or in operations where x-rays are used to assist in proper execution of surgical procedures. Although these high atomic number metals re-radiate x-rays at lower energy levels than the original x-rays, it is possible that the user of the apron would be exposed to unsafe levels of these re-radiated x-rays. The problem has potentially increased as the industry has moved to light weight aprons which employ elements with somewhat lower atomic numbers, such as tin, antimony, or iodine, caesium, barium, or the rare earth metals, elements much more likely to emit higher levels of re-radiation. This invention provides another basis to resolve and avoid this problem.

Whereas particular embodiments of the present invention have been described above as examples, it will be appreciated that variations of the details may be made without departing from the scope of the invention. One skilled in the art will appreciate that the present invention can be practiced by other than the disclosed embodiments, all of which are presented in this description for purposes of illustration and not of limitation. It is noted that equivalents of the particular embodiments discussed in this description may result in the practice of this invention as well. Therefore, reference should be made to the appended claims rather than the foregoing discussion or examples when assessing the scope of the invention in which exclusive rights are claimed.

The following invention is claimed:

1. A multi-layer, flexible, radiation shielding material which can be formed into a garment, for limiting the radiation exposure of medical and industrial workers to scattered radiation from x-ray procedures, the material comprising: two or more layers of a polymeric sheet or film, each layer having dispersed throughout the polymer sheet a high atomic number element, at least one layer being a barrier layer comprising an element having an atomic number at least equal to 55; and at least one layer being a secondary radiation shielding layer comprising an element having an atomic number at least equal to 48 such that the net radiation reaching a worker wearing a garment made from the multi-layer shielding material is not more than the amount reaching a worker exposed to the same conditions and wearing a garment made from a material having dispersed therethrough lead particles and having a total weight at least equal to that of the garment of this invention.

2. The multi-layer, flexible, radiation shielding material of claim 1 wherein the barrier layer has a k-edge value of not greater than 50.2 keV, and the secondary layer has a k-edge value of less than the k-alpha-1 line of the barrier layer.

3. A radiation shielding garment manufactured from the multi-layer, flexible, radiation shielding material of claim 1.

4. The multi-layer, flexible, radiation shielding material of claim 1 wherein the secondary layer contains only metals having an atomic number of not greater than 56.

5. The multi-layer, flexible, radiation shielding material of claim 4 wherein the secondary layer comprises metals selected from the group consisting of antimony, tin, barium and cesium or their compounds.

6. The multi-layer, flexible, radiation shielding material of claim 1 consisting of a barrier layer and a secondary layer, wherein the barrier layer comprises a metal selected from the group consisting of gadolinium, lanthanum, cerium, barium and cesium and their compounds and wherein the secondary layer comprises a metal selected from the group consisting of antimony and tin.

7. The multi-layer, flexible, radiation shielding material of claim 1 wherein the barrier layer comprises a mixture of metals consisting of antimony in the weight range of 30% to 60% by wt and thallium in the weight range of 70% to 40% by wt.

8. A radiation shielding garment manufactured from a multi-layer, flexible, radiation shielding material to attenuate the amount of exposure to scattered radiation from medical x-ray procedures by at least 89% with a total weight less than that of a standard lead layer having a thickness of about 0.25 mm, the multi-layer, flexible, radiation shielding material having at least two layers, a first layer forming a barrier layer and comprising a flexible polymer sheet containing a metallic element having an atomic number at least equal to 55, and a second layer forming a secondary a secondary radiation shielding layer comprising an element having an atomic number at least equal to 48, wherein the barrier layer is located closer to the wearer than is the secondary layer.

9. The radiation shielding garment manufactured from a multi-layer, flexible, radiation shielding material of claim 8, wherein the barrier layer contains lead.

10. The radiation shielding garment manufactured from a multi-layer, radiation shielding material of claim 8, comprising at least three layers of flexibly material, wherein the barrier layer is located in a middle layer position, wherein each of the outermost layer, distal from the wearer, and the innermost layer proximal to the wearer, comprise a metal having an atomic number of not greater than 56.
